(19) United States
(12) Patent Application Publication
(10) Pub. No.: US 2011/0022531 A1
(43) Pub. Date: Jan. 27, 2011

(54) Electronic Verification Software

(76) Inventor: Robert L. Jordan, San Francisco, CA (US)

Correspondence Address: DeLeon Law Group PC, 2500 Dallas Parkway, Suite 260, Dallas, TX, 75093, US

(21) Appl. No.: 12/688,652

(22) Filed: Jan. 15, 2010

Related U.S. Application Data
(60) Provisional application No. 61/145,024, filed on Jan. 15, 2009.

(51) Int. Cl. G06Q 10/00

(52) U.S. Cl. 705/321

(57) ABSTRACT

A method is described herein for managing employees and their workforce verification.

### CROSS-REFERENCE TO RELATED APPLICATIONS

Applicant claims priority based on provisional application Ser. No. 61/145,024 filed on Jan. 15, 2009, the entire content of which are incorporated herein by reference.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 is a screen shot of a home page of an embodiment;

FIG. 2 is a screen shot of a home page with an emphasis on the login button;

FIG. 3 is a screen shot of a secure login page;

FIG. 4 is a screen shot of a home page once a member logs in;

FIG. 5 is a screen shot of a employee tab;

FIG. 6 is a screen shot of a reminders tab;

FIG. 7 is a screen shot of a vendors tab;

FIG. 8 is a screen shot of a reports tab;

FIG. 9 is a screen shot of a utilities tab;

FIG. 10 is a screen shot of a news tab;

FIG. 11 is a screen shot of a settings tab;

FIG. 12 is a screen shot of a frequently asked questions tab;

FIG. 13 is a screen shot of an add employee form;

FIG. 14 is a screen shot of an online Form I-9 creation page;

FIG. 15 is a screen shot shown if the Form I-9 is compliant;

FIG. 16 is a screen shot that is displayed if the employee is authorized to work;

FIG. 17 is a screen shot of a listing of an employee's I-9 Form in English and Spanish;

FIG. 18 is a screen shot of the history of the employee;

FIG. 19 is a screen shot of a listing of employees' status;

FIG. 20 is a screen shot that is displayed when a social security number does not match the employee's name (also known as a Tentative Non-Confirmation response or “TNC”);

FIG. 21 is a screen shot that shows user options after receiving a TNC response;

FIG. 22 is a screen shot of pre-completed forms created after a TNC has been contested by the employee;

FIG. 23 is a letter notice to employee of TNC in English;

FIG. 24 is a letter notice to employee of TNC in Spanish;

FIG. 25 is a letter notice to employee of referral to the Social Security Administration in English;

FIG. 26 is a screen shot of a Social Security Office Locator;

FIG. 27 is a screen shot of an example map of a Social Security Office;

FIG. 28 is a screen shot of a reminders notification located on the homepage;

FIG. 29 is a screen shot of details of a vendor;

FIG. 30 is a sample E-vite letter distributed to vendors;

FIG. 31 is a screen shot of a listing of vendors and their level of compliance; and

FIG. 32 shows example remote hire E-vite letter, notary notice form and remote hire instruction form;

FIG. 33 shows a flowchart for an embodiment;

FIG. 34 shows another flowchart for an embodiment;

FIG. 35 shows another flowchart for an embodiment; and

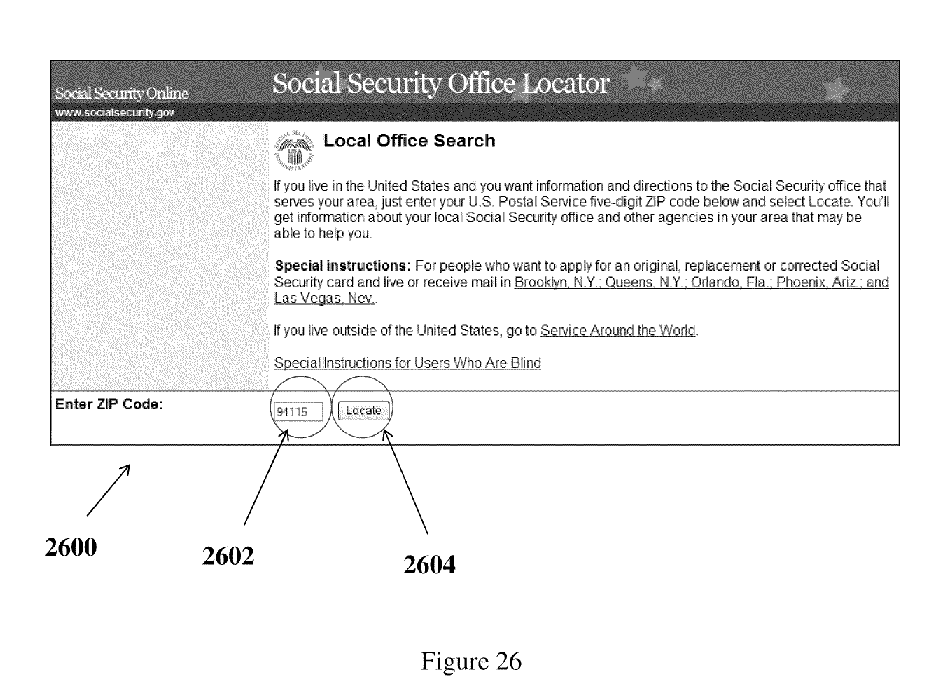

FIG. 26 shows another flowchart for an embodiment.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

Employers are faced with additional regulations and intense pressure when it comes to verifying the employment eligibility status of new and current employees, including social security numbers, immigration status, and criminal or domestic warrants. As the Federal and State governments layer documentation regulations and continue to increase penalties on employers who fail to verify employees, it is becoming more important to have a quick and comprehensive way to verify employees' employment eligibility and remind employers of deadlines and other issues.

Conventional software provides several benefits to employers, including automated alerts of pending expirations, the work to be performed and the employee deadlines; error detection in the subject forms, such as the Form I-9; “e-signature”, “e-completion” and storage options with forms; full compliance with all Form I-9 documentation requirements per INA §274a and the 1997 Interim rule; and reporting functions that include expiration dates, upcoming re-verification dates and summary management reports.

While these benefits are necessary, there's another group of benefits that would help employers—none of which are contained within conventional software packages. For example, employers would benefit by utilizing software that contains the forms and information, such that the employer is compliant with section 508 of the Disabilities Act. In addition, the software should be Statement on Auditing Standards Section 70 compliant. Finally, ideal software should include a bundle of efficiency products, such as accessibility from a hand-held device, administrative permissions, error checking at the web application level prior to e-transmission, insertion of Employer's Federal Contract(s) information, guided workflow with auto-error correction and suggestions, paperless workflow of the entire E-Verification process, including form storage, pre-completion of referral letters and Temporary Non-Compliance (“TNC”) notices in both English and Spanish, real-time monitoring of the Employer's vendors, sub-contractors and suppliers' E-Verify compliance status, upload of employee data for multiple employees; and upload of paper Form I-9s into the web application.

An embodiment of the invention includes software for use in multiple delivery/access formats, including a computer, Internet interface, hand-held interface and other suitable devices. This novel software package incorporates all of the conventional benefits above, along with all of the ideal benefits and efficiency packages previously outlined.

In this embodiment, the software packages, is referred to as ACCUFORM I-9, and provides tools to work with and complete a Form I-9, along with all of the related requirements. This embodiment is a web-based software application that enables: 1) U.S. employers to E-Verify new employees' legal right to work in the United States; and 2) U.S. employers, that are Federal contractors, to E-Verify new and existing employees' legal right to work in the United States. In addition, this embodiment enables an employer to conduct Form I-9 employment eligibility verifications through the Department of Homeland Security (“DHS”) and the Social Security Administration (“SSA”). Using information obtained from newly hired employees, an employer is able to E-Verify the accuracy of Social Security Numbers, Immigration “A” numbers, and I-94 arrival/departure numbers and in real-time obtain the employees' legal right to work status with a DHS-issued verification number, which is stamped and stored on the Employee's Form I-9, In addition to E-Verifications, and recognizing the shortcomings of the Federal government's E-Verify system, this embodiment provides the employer with the following services to help easily manage the Form I-9 process: (a.) Step-by-Step guidance where an employer is prompted to answer questions, and those answers are propagated into the electronic Form I-9 for electronic submission to E-Verify, as well as other forms and reports; (b.) Auto Error-Detection that simplifies the document completion process and virtually eliminates processing errors; (c.) Electronic signature that utilizes E-Sign Act compliant click-to-sign solution; (d.) Secure, paperless Form I-9 storage that provides anytime, anywhere online access for updating, re-verification and governmental audit/inspection; (e.) Automated alerts for 90, 60, 30, 10, 5 and 1 day(s) in advance of employees' expiring work authorizations, which will enable employees to renew their work authorization documents and legally continue to work without interruption; (f.) Pre-completed Temporary Non-Confirmation Letters (English and Spanish versions) that enable the employer to view, print and deliver to its employees copies of such documents for use by their employees in their effort to resolve their issues with either SSA or DHS; (g.) Powerful Reporting tools that create reports defining authorized, pending, and denied employees, sorted by name, location, and date; and (h.) 24/7 Access to employers files from any web-enabled device.

Some additional benefits of the embodiment are: (a.) providing peace of mind by confirming new employees' Social Security and immigration documents; (b.) reducing costs by simplifying and improving efficiency of the Form I-9 process; (c.) substantially decreasing human errors in completing Form I-9s; (d.) reducing exposure to government audits, financial penalties and negative publicity resulting from employer non-compliance, and (e.) improving accuracy of payroll and tax reporting and virtually eliminating SSA inquiries concerning unmatched Social Security numbers with the SSA's Social Security number verification service.

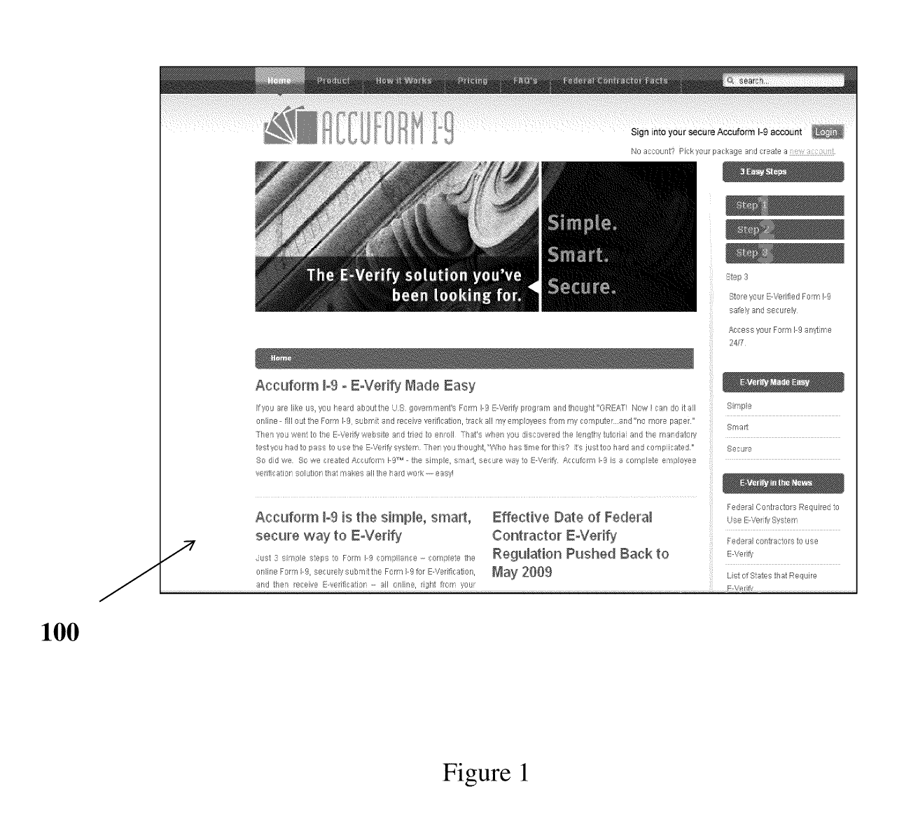

Now turning to FIG. 1, an example homepage 100 of this embodiment is shown. This example page 100 informs viewers about the system of this embodiment while also informing viewers about Form I-9s and the employment eligibility verification process. The page 100 also contains other related helpful information about the verification process.

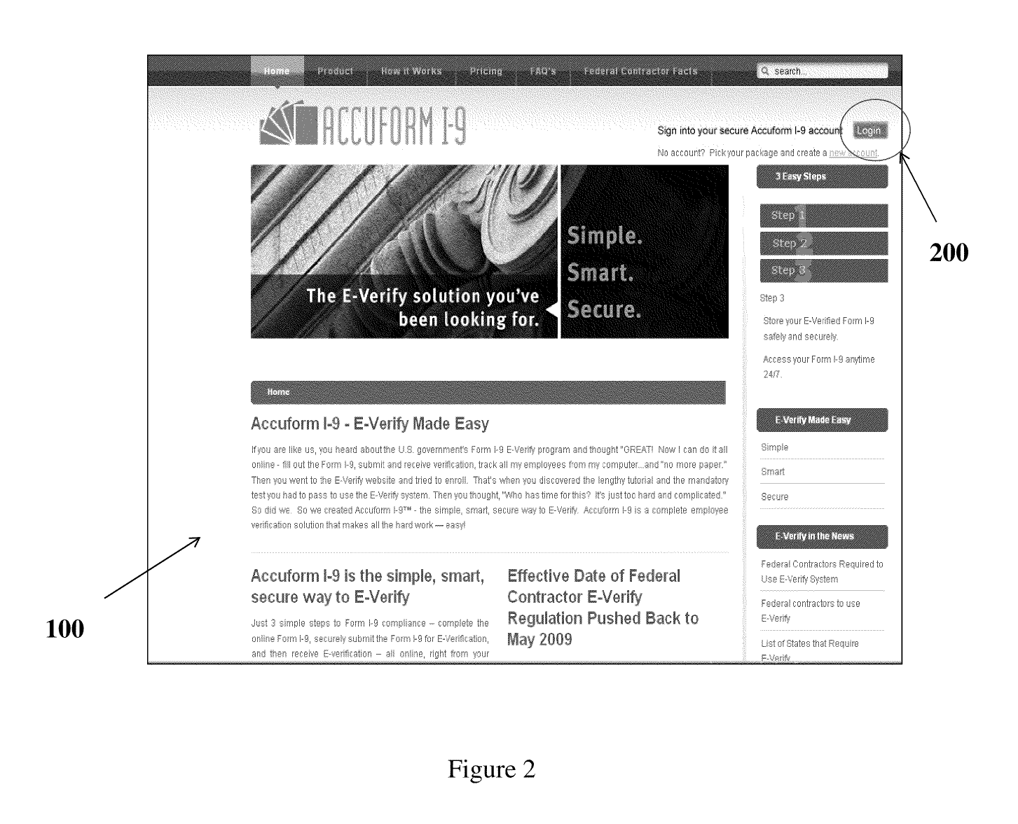

FIG. 2 illustrates the same homepage 100 with the login button 200 highlighted. A member clicks on the login button to initiate logging into the system of this embodiment.

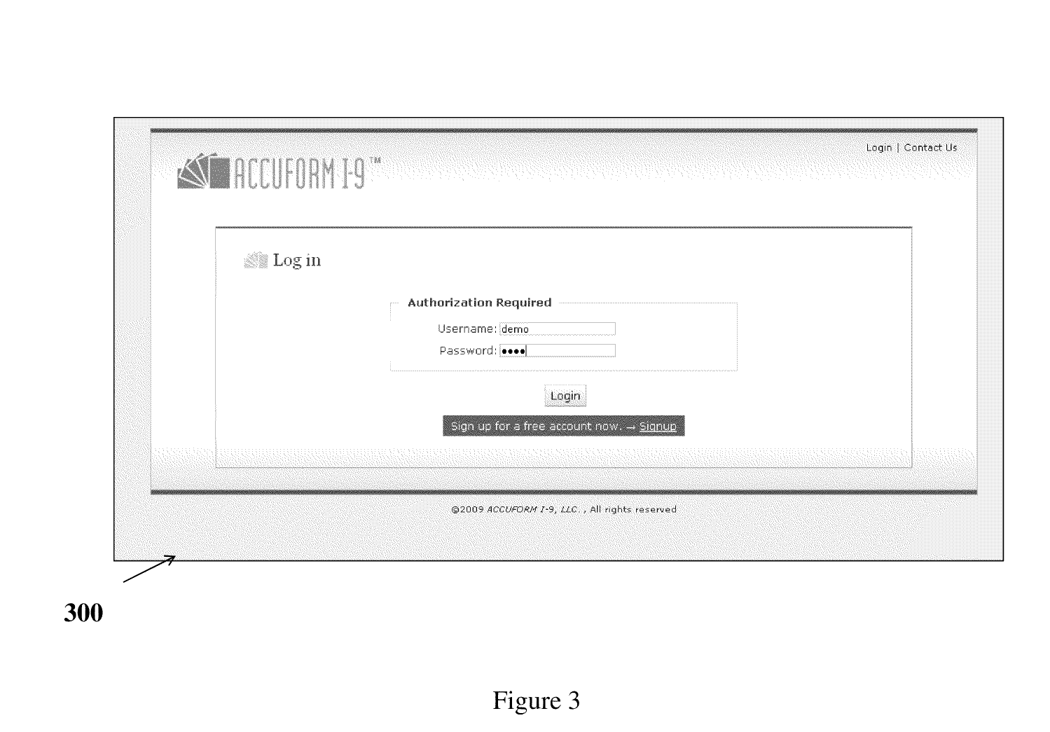

FIG. 3 illustrates the secure log in webpage 300 where a member types in his username and password to log into the system.

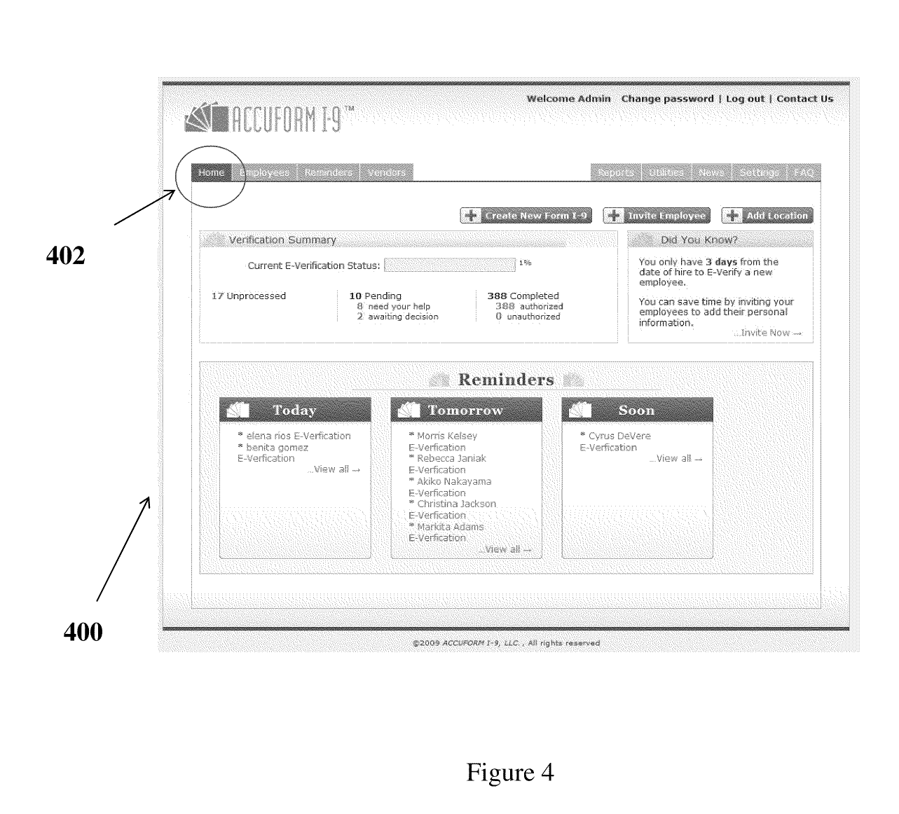

FIG. 4 illustrates the homepage 400 that is displayed in this embodiment once a User logs into the system. The home tab 402 is also highlighted on this example page 400. The homepage 400 enables a User to create new Form I-9, invite employees and add locations. The page 400 also displays Reminders that help the User manage their Form I-9s. The page 400 also displays the User's verification summary along with other helpful hints.

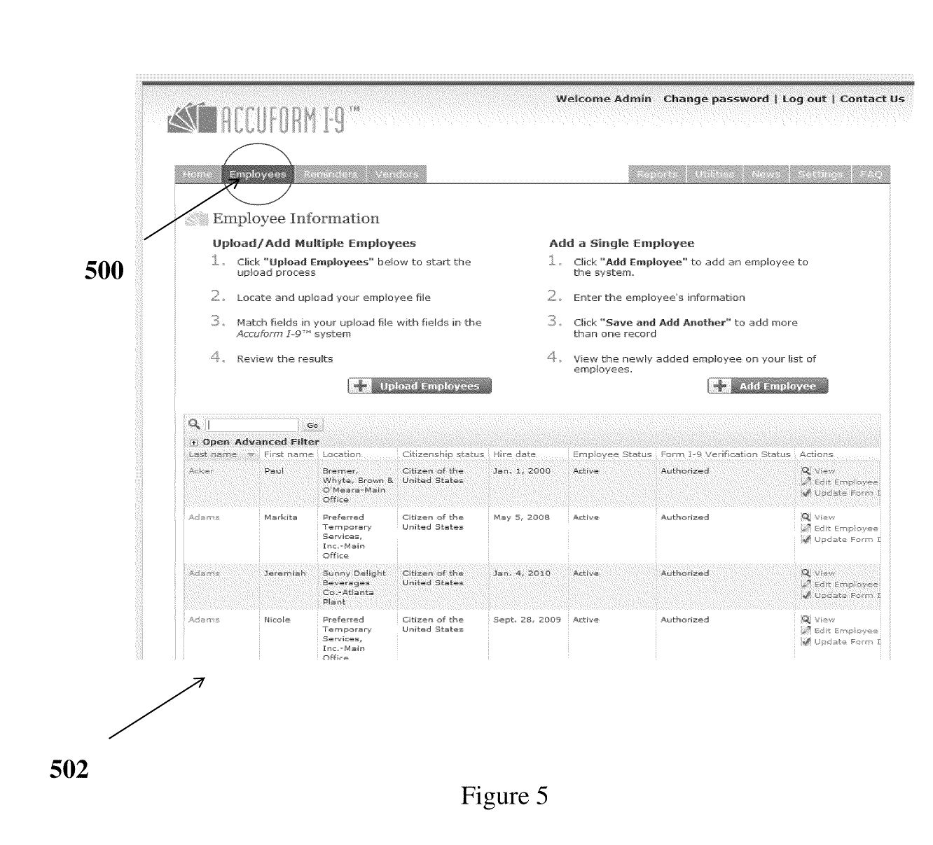

Now turning to FIG. 5, after a User clicks on the Employee tab 500, an employee page 502 is shown. Using this page 502, a User can upload/add multiple employees and/or add a single employee. This page 502 also allows a User to search for employees.

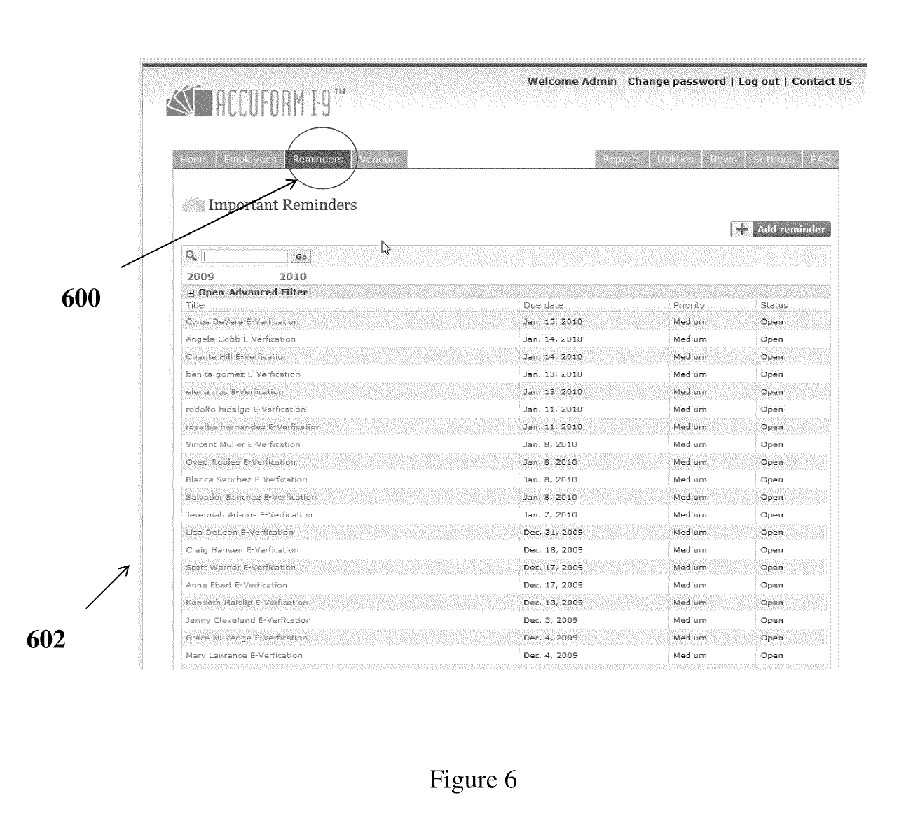

Now turning to FIG. 6, after a User clicks on the Reminders tab 600, an employee page 602 is shown. Using this page 602, a User can add reminders, view a listing of reminders, and even search for reminders.

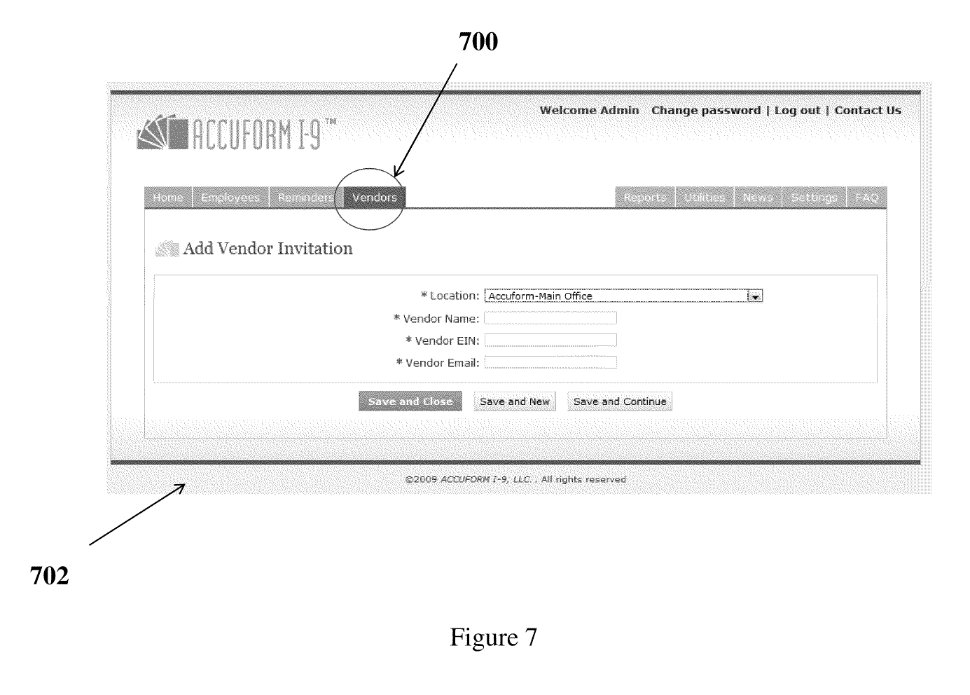

Now turning to FIG. 7, after a User clicks on the Vendors tab 700, a vendors page 702 is shown. Using this page 702, a User can add vendors.

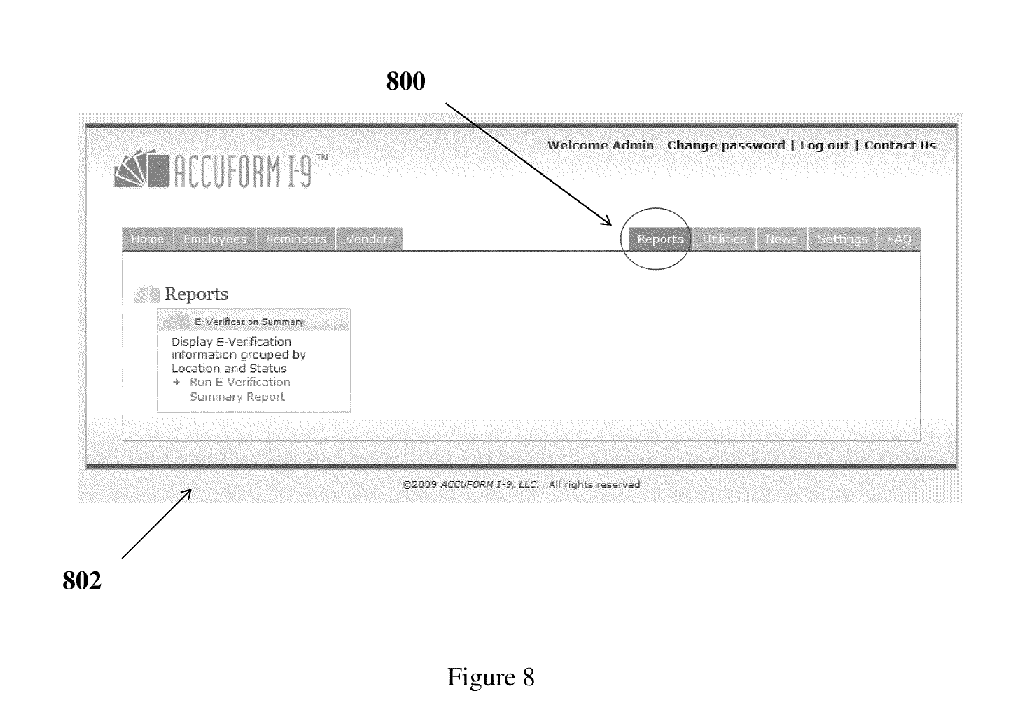

Now turning to FIG. 8, after a User clicks on the Reports tab 800, a reports page 802 is shown. Using this page 802, a User can run E-verification Summary Reports.

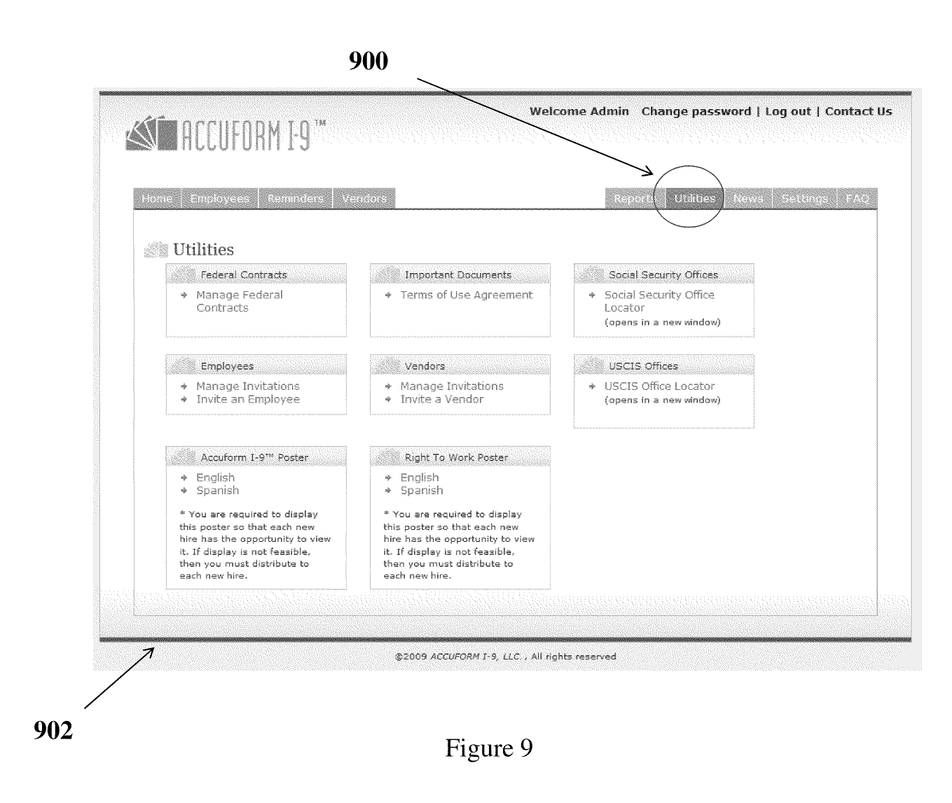

Now turning to FIG. 9, after a User clicks on the Utilities tab 900, a utilities page 902 is shown. Using this page 902, a User can manage federal contracts, view terms of the use agreement, locate social security offices, manage invitations, invite employees to fill out information, manage vendor invitations, invite vendors, locate USCIS offices, and print out Form I-9 Posters and Right to Work Posters in both English and Spanish.

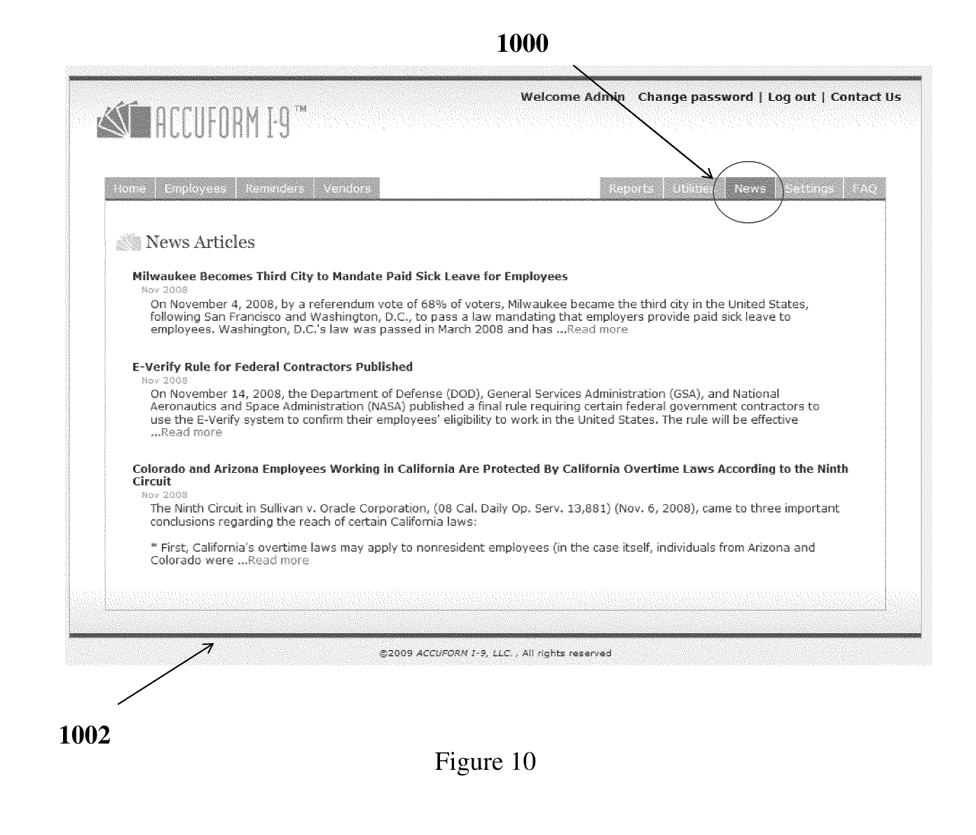

Now turning to FIG. 10, after a User clicks on the News tab 900, a news page 902 is shown. From this page 902, a User can view all the latest news articles related to important employee information.

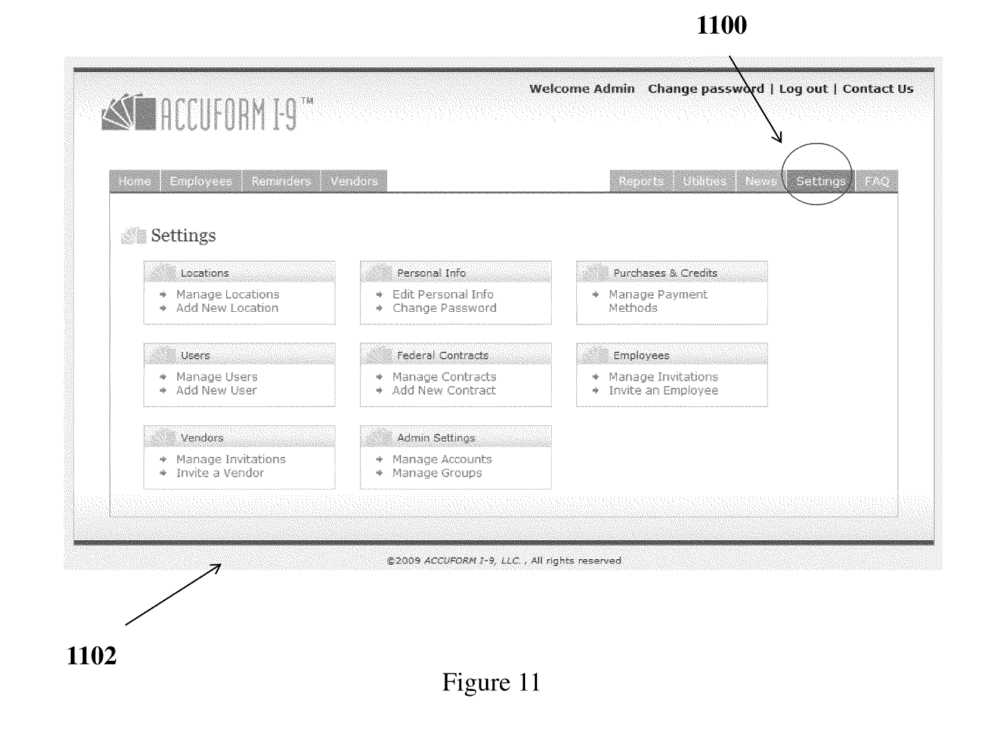

Now turning to FIG. 11, after a User clicks on the Settings tab 1100, a settings page 1102 is shown. From this page 1102, a User can manage and add new locations, edit personal information, manage payment methods, manage and add users, manage and add new contracts, manage invitations to employees, manage invitations to vendors, and manage accounts and groups.

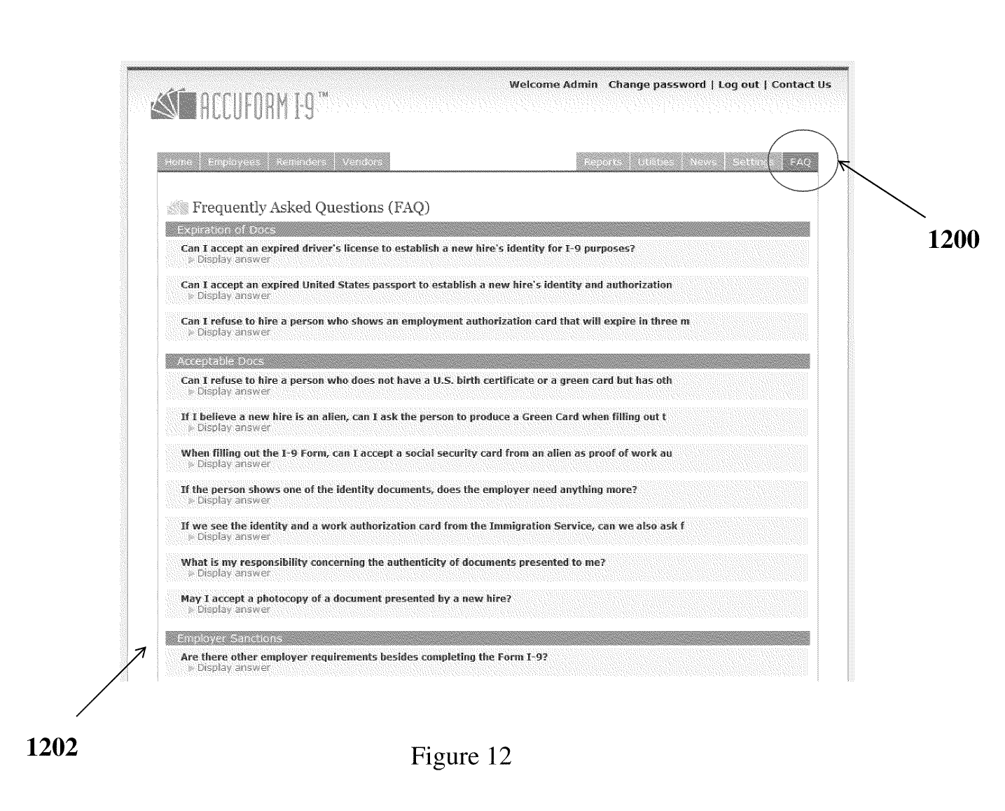

Now turning to FIG. 12, after a User clicks on the FAQ tab 1200, a frequently asked questions page 1202 is shown. This page 1202 allows a User to view frequently asked questions along with their answers.

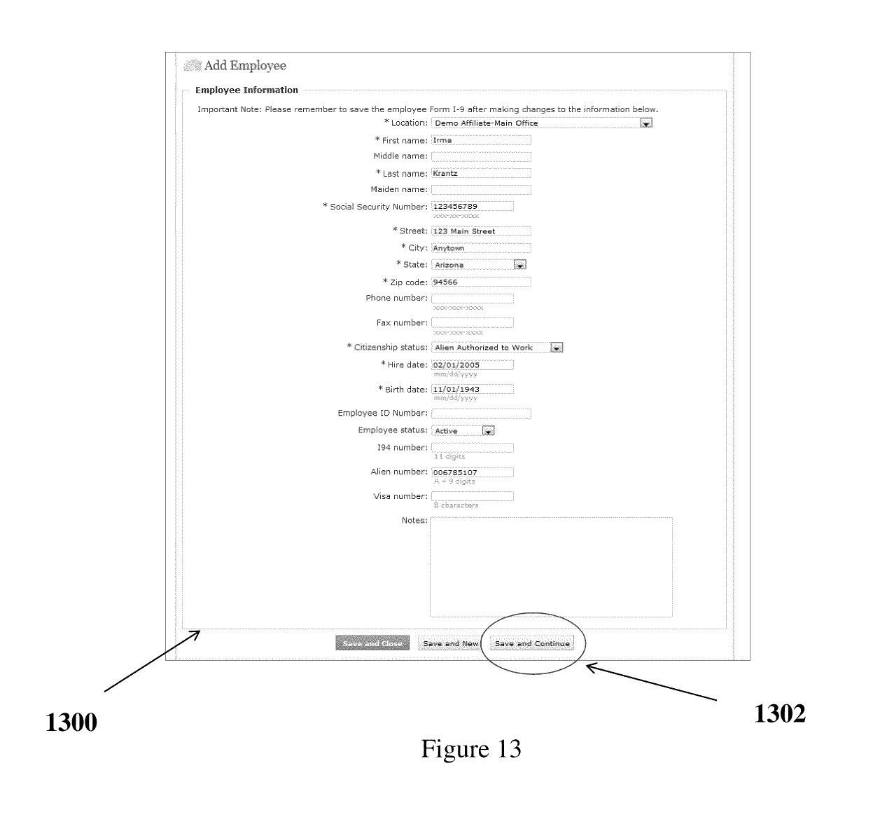

For purposes of illustration, the Form I-9 process is described with a fictitious person, Irma Krantz. FIG. 13 illustrates an add employee page 1300. Using this page 1300, a User can add a new employee by inputting all the requisite employee information and then clicking on the save and continue button 1302.

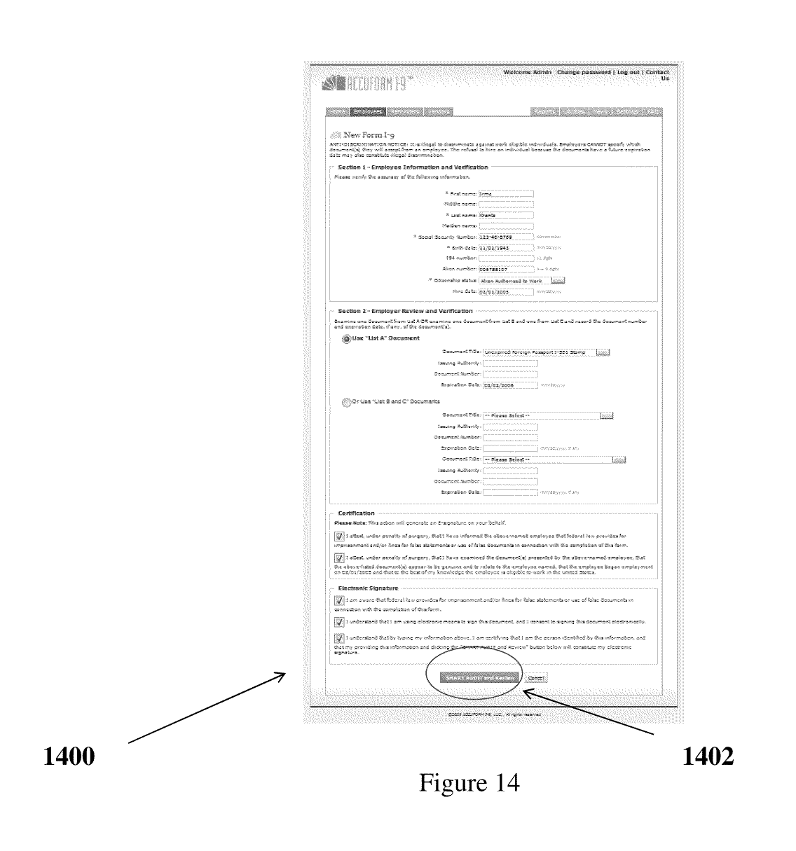

As shown in FIG. 5, a User can add a Form I-9 for employees. One example is shown in FIG. 14. New Form I-9 page 1400 illustrates the addition of Irma Krantz. Once the User adds all of the relevant information for the new employee, the User clicks on the smart audit and review button 1402 to complete the addition.

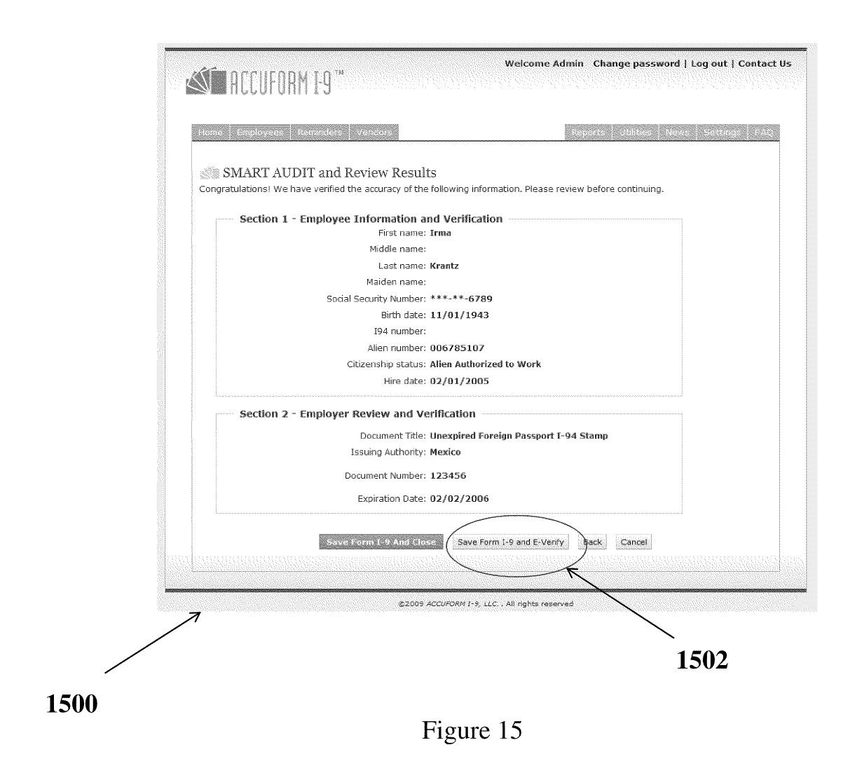

FIG. 15 illustrates a web page 1500 that results when the employee Form I-9 reviewed and is considered accurate and compliant. The User then clicks on the Save Form I-9 and E-verify button 1502 to save the employee's information and also begin the E-Verify process.

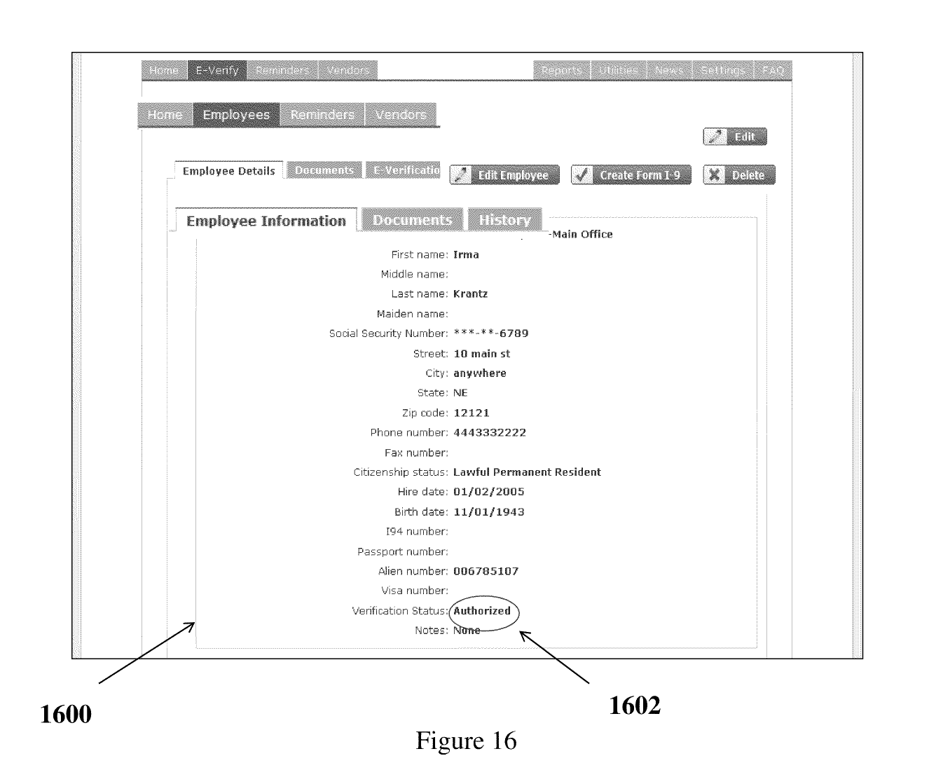

FIG. 16 illustrates a web page 1600 when the added employee is authorized to work by E-Verify. In this figure, the verification status of Authorized 1602 is highlighted.

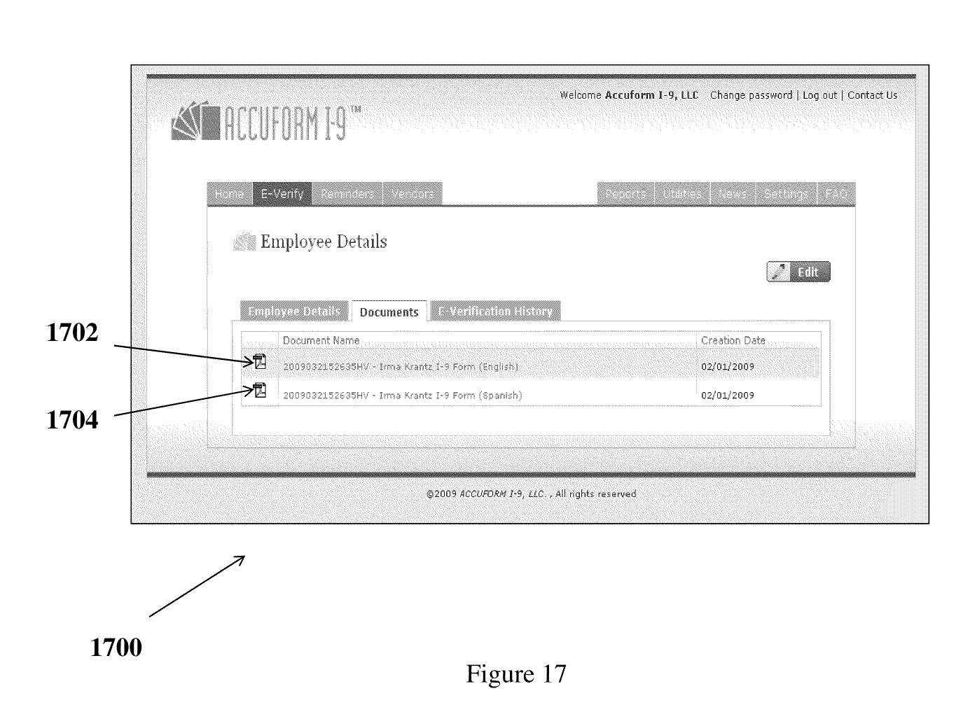

FIG. 17 illustrates a web page 1700 with a listing of the completed Form I-9's in English 1702 and Spanish 1704.

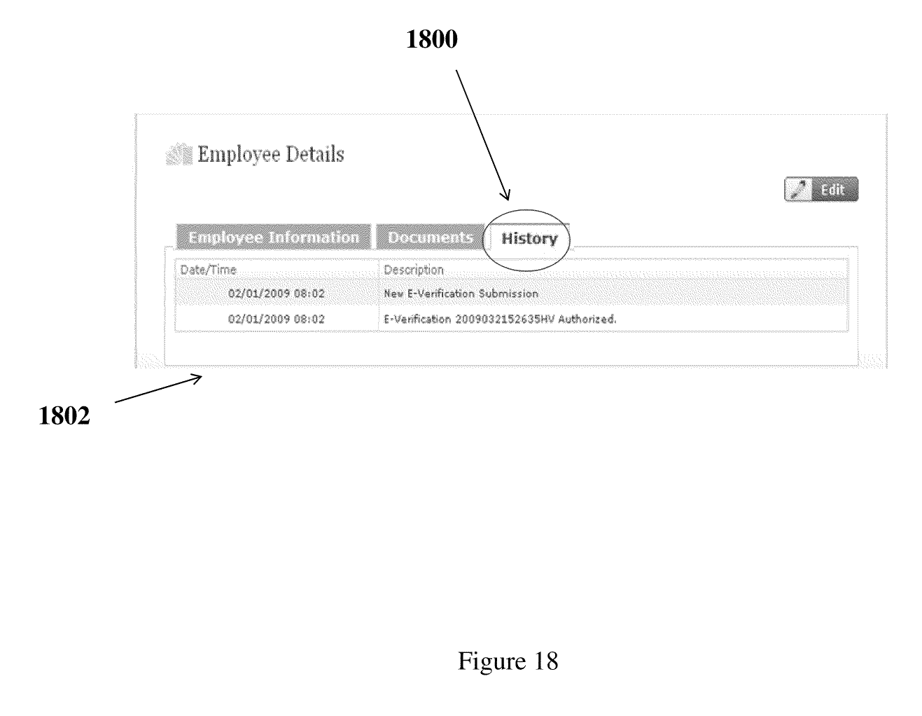

Now turning to FIG. 18, if the User then clicks on the History tab 1800, a web page 1802 with the history adding of the employee is shown. The history page 1802 enables the User to be able to audit the addition of employees.

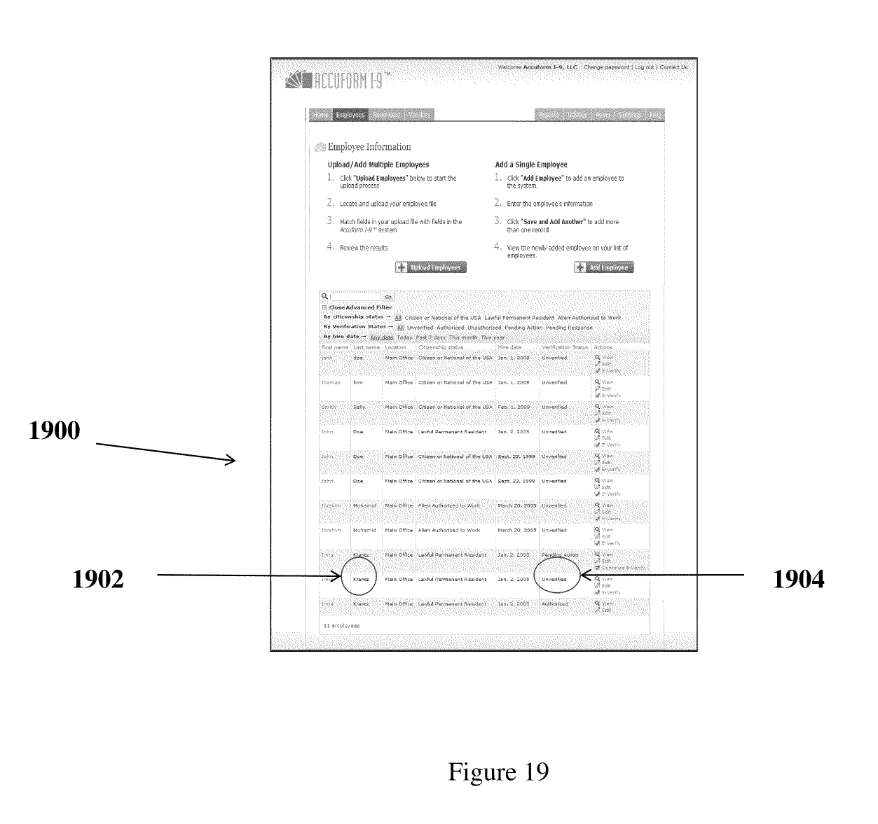

An example when the addition of an employee that is not authorized to work is now described. FIG. 19 illustrates a web page 1900 of a listing of employees that includes verification status. As shown, the listing of Irma Krantz 1902 indicates that she is unauthorized 1904 to work.

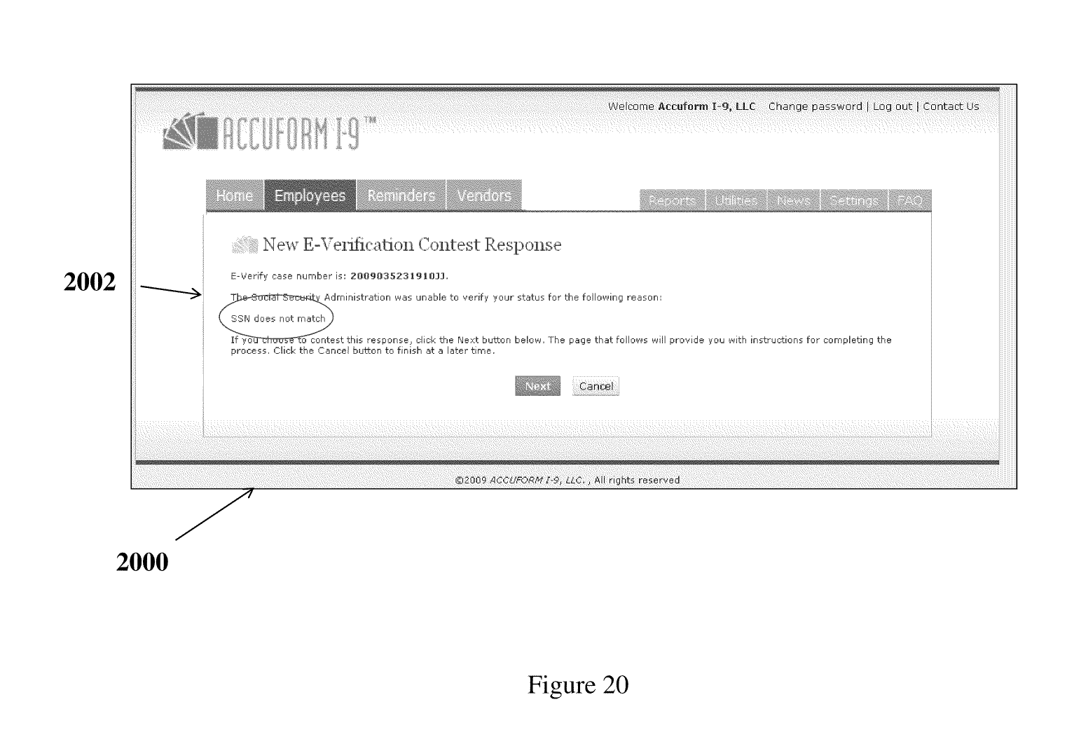

The web page 2000 in FIG. 20 indicates that the social security administration has found that the social security number does not match 2002. This type of response is known as a TNC. The User would then click on Next button.

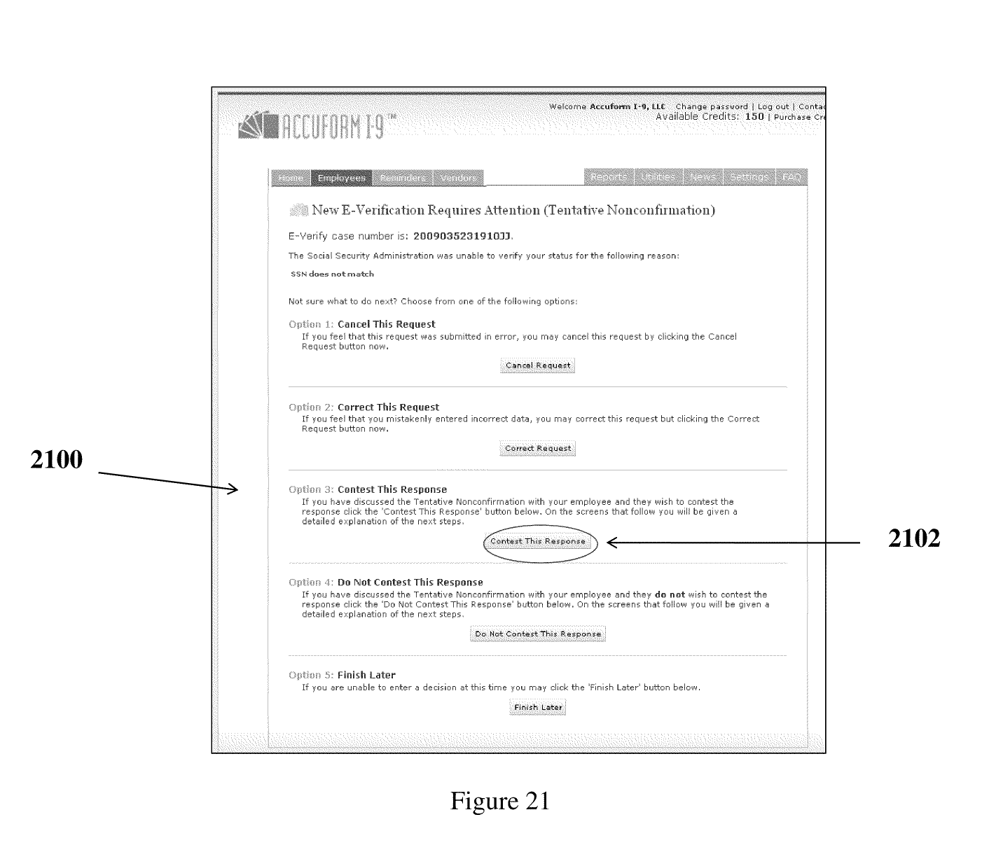

The web page 2100 is then displayed as shown in FIG. 21. Although the User is given options to cancel request, correct request, contest this response 2102, do not contest this response, and to finish later, this example illustrates the employee's request to contest this response 2102.

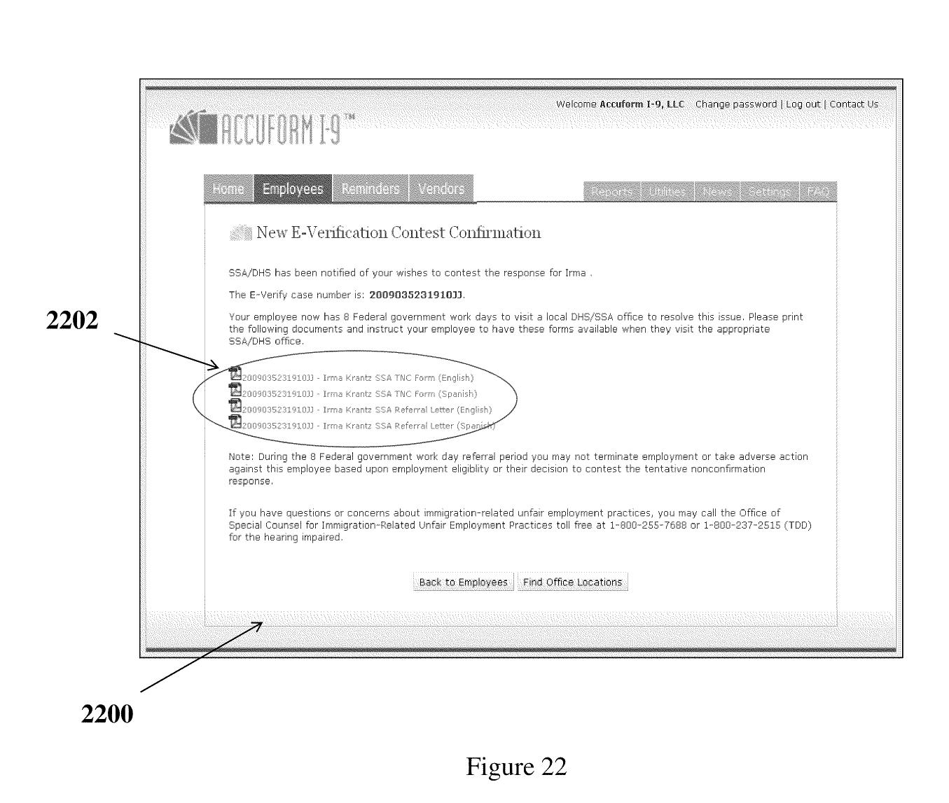

The system then displays the web page 2200 as illustrated in FIG. 22. As shown, the system automatically generated tentative non-confirmation notices in English and Spanish as well as social security referral letters in English and Spanish. The listing 2202 is shown in the middle of the web page 2200.

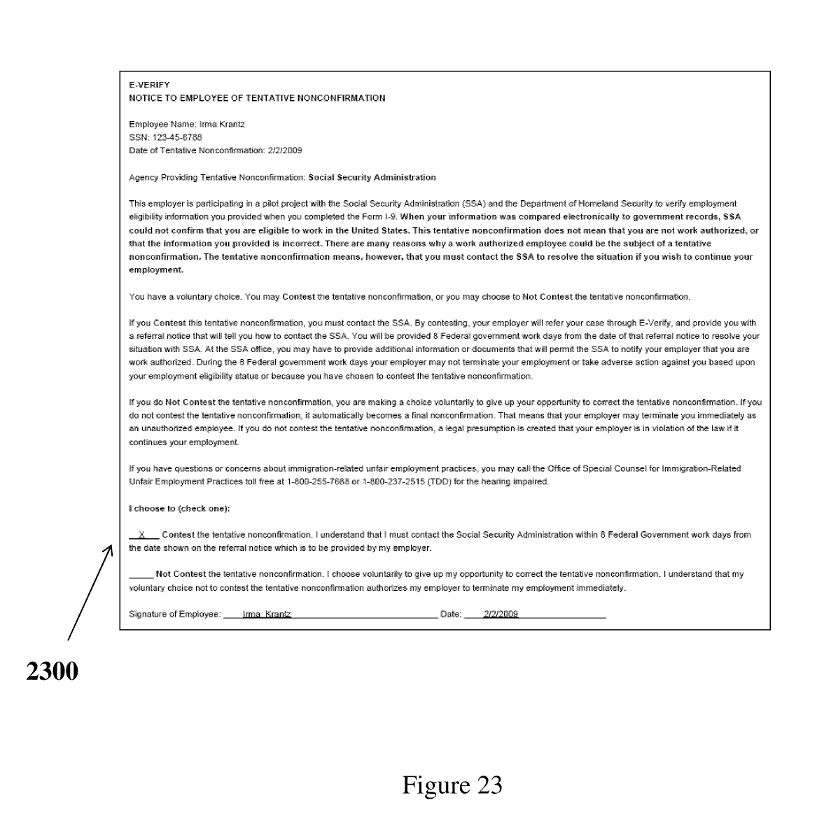

FIG. 23 illustrates an example notice of non-confirmation 2300 in English.

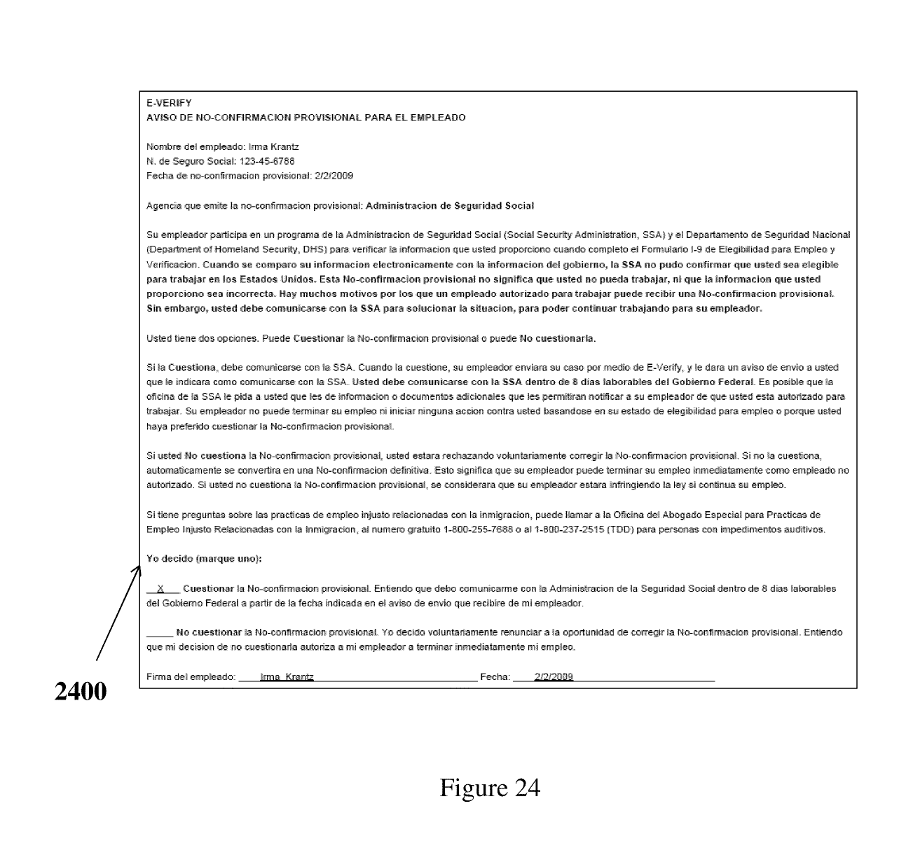

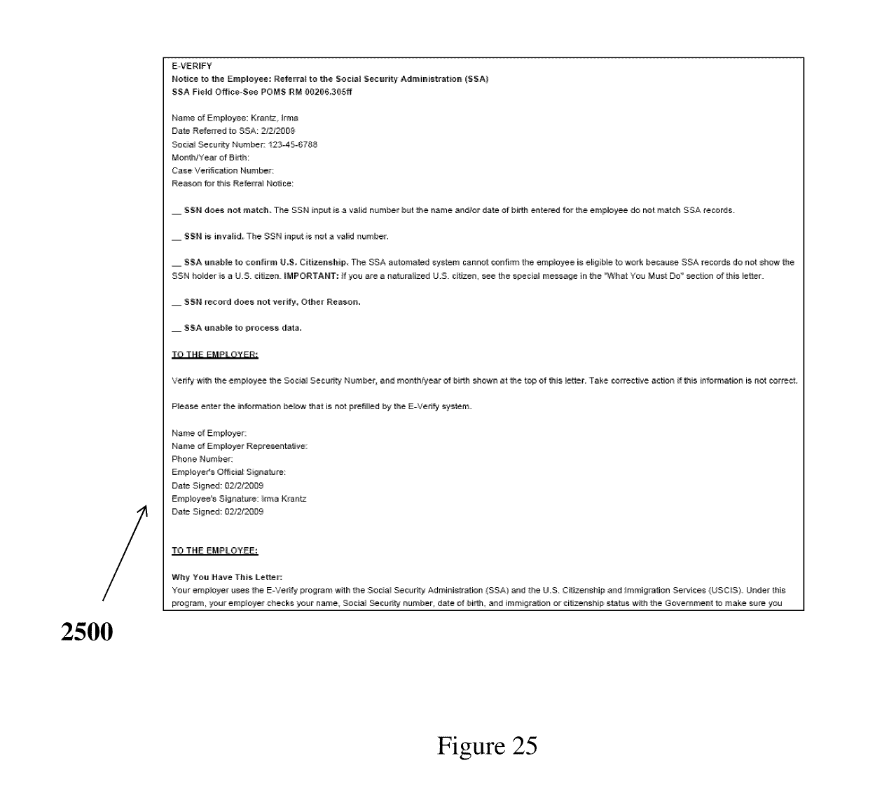

Similarly, FIG. 24 illustrates an example notice of non-confirmation 2400 in Spanish.

Moreover, FIG. 2500 illustrates an example referral notice 2500 in English. Although an example referral notice is not shown in Spanish, the system automatically generated one.

FIG. 26 illustrates an example web page 2600 that can help the User find a social security office. The User inputs a zip code 2602 and then clicks on the locate button 2604.

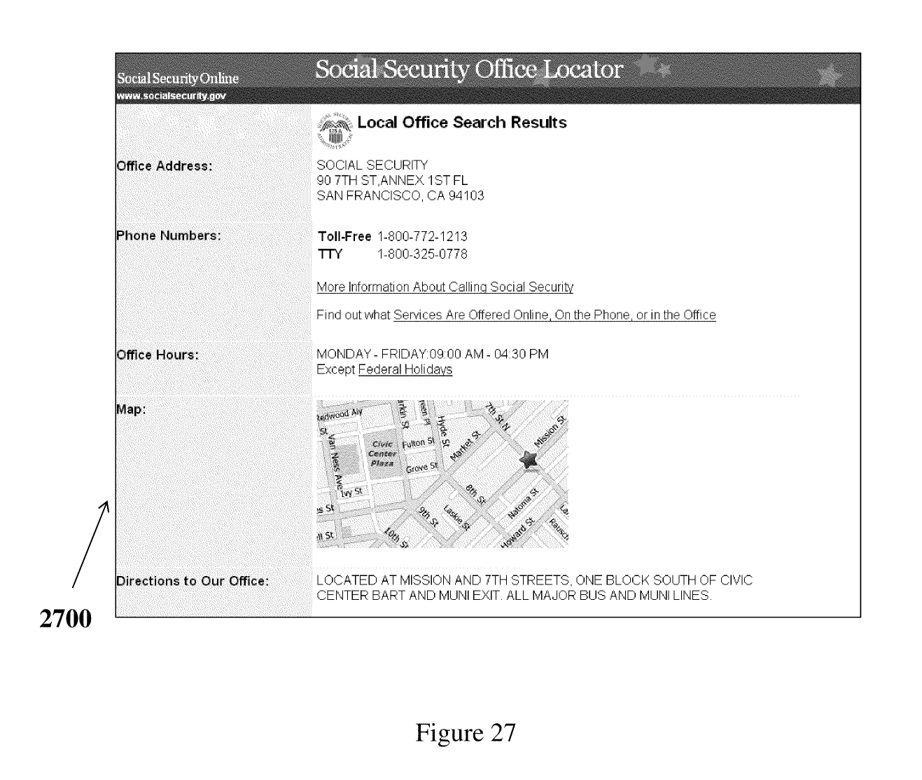

FIG. 27 illustrates a resulting web page 2700 with the location and other information of the social security office nearest the entered zip code.

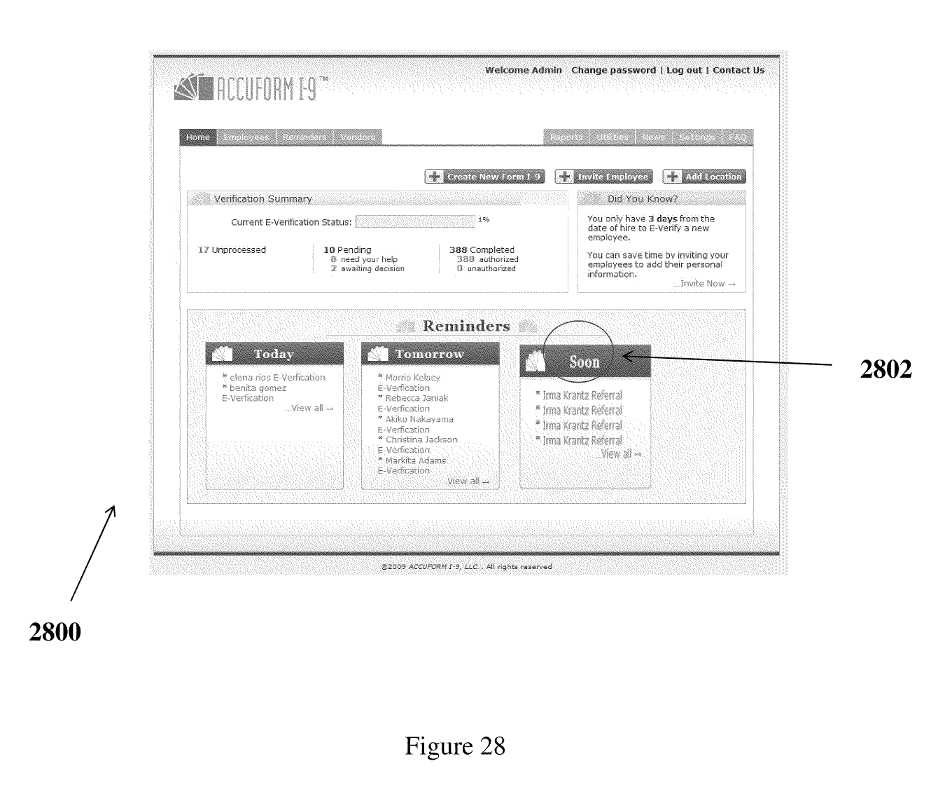

FIG. 28 illustrates another example home page 2800 listing reminders. In this example, reminders 2802 to meet with Irma Krantz soon are created since her tentative non-confirmation was contested.

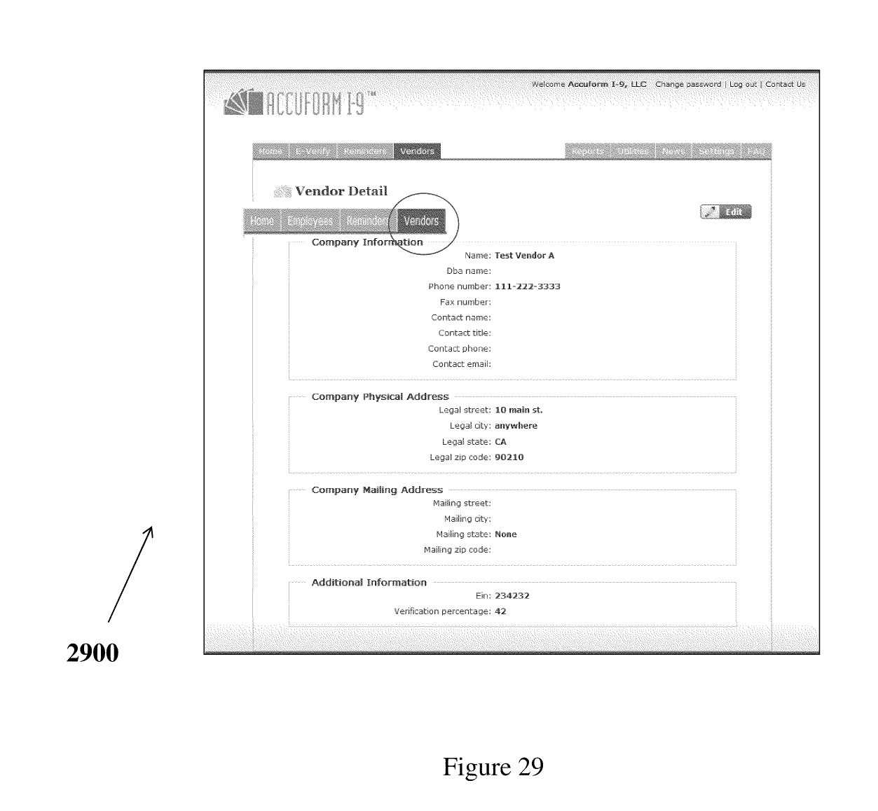

This embodiment also includes the ability to add vendors as shown in FIG. 29. The Vendor Detail page 2900 allows a User to add company information, a physical address, a mailing address and additional information for a Vendor.

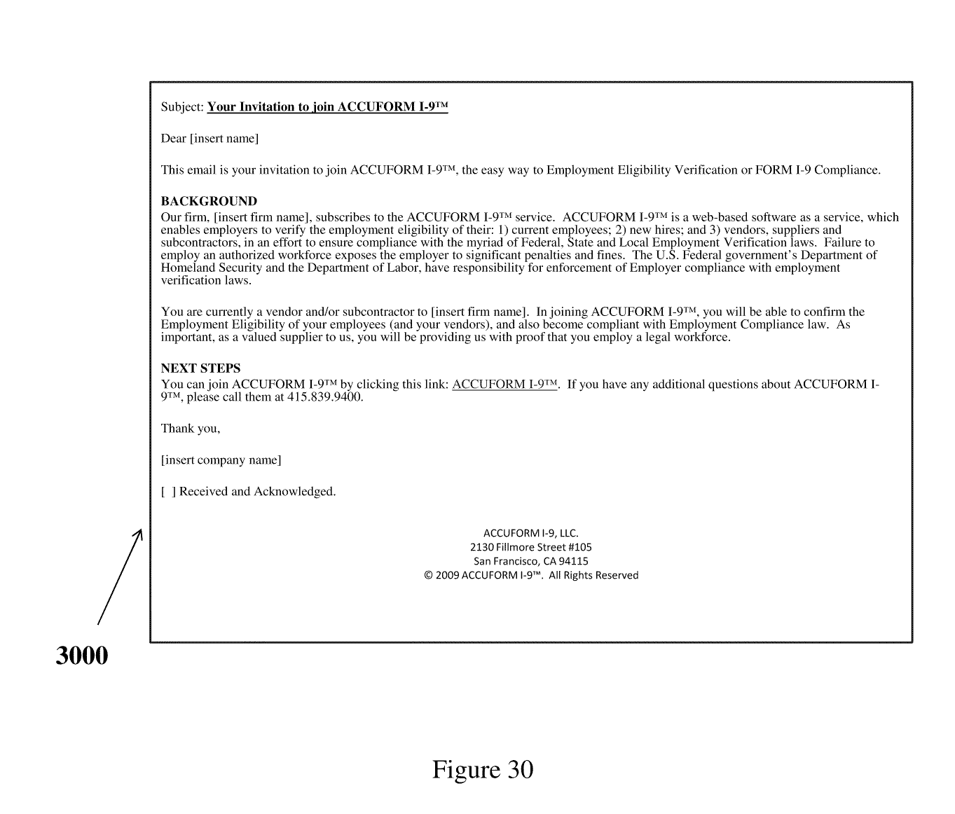

FIG. 30 illustrates an example E-vite letter 3000 that can be sent vendors, suppliers and subcontractors.

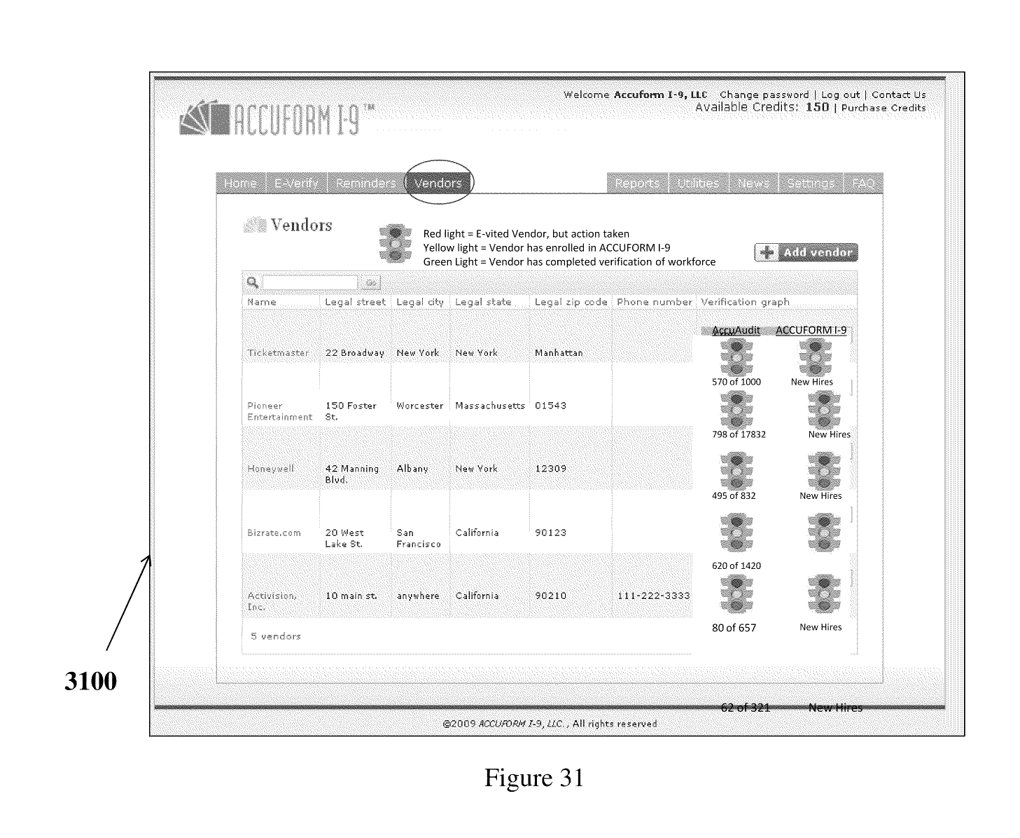

FIG. 31 illustrates a web page 3100 with a listing of vendors and status regarding worker verification compliance. In this example, red, yellow and green lights are used to indicate levels of workforce verification.

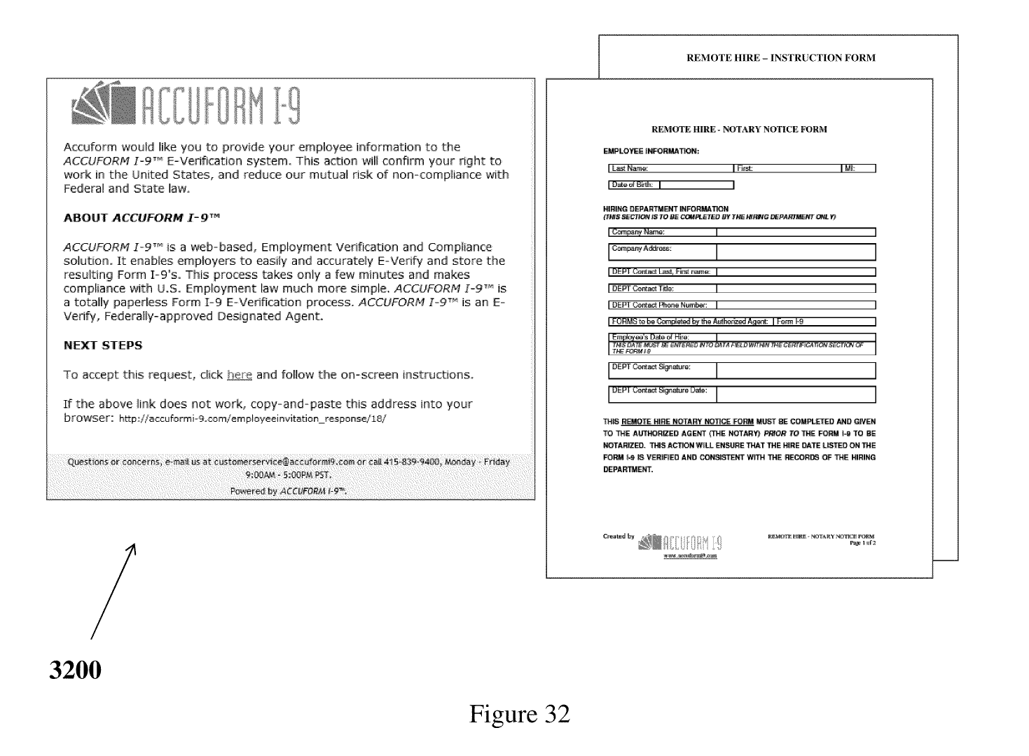

The system also enables a User to E-vite their remote employees to complete their Form I-9 online. FIG. 32 illustrates an example form 3200 with instructions. Of course, these forms can change as the requirements for workforce verification change.

The system also includes invoicing and billing, auto purge of records once terminated in accordance with requirements and the capability of downloading of entire database for Department of Labor inspectors.

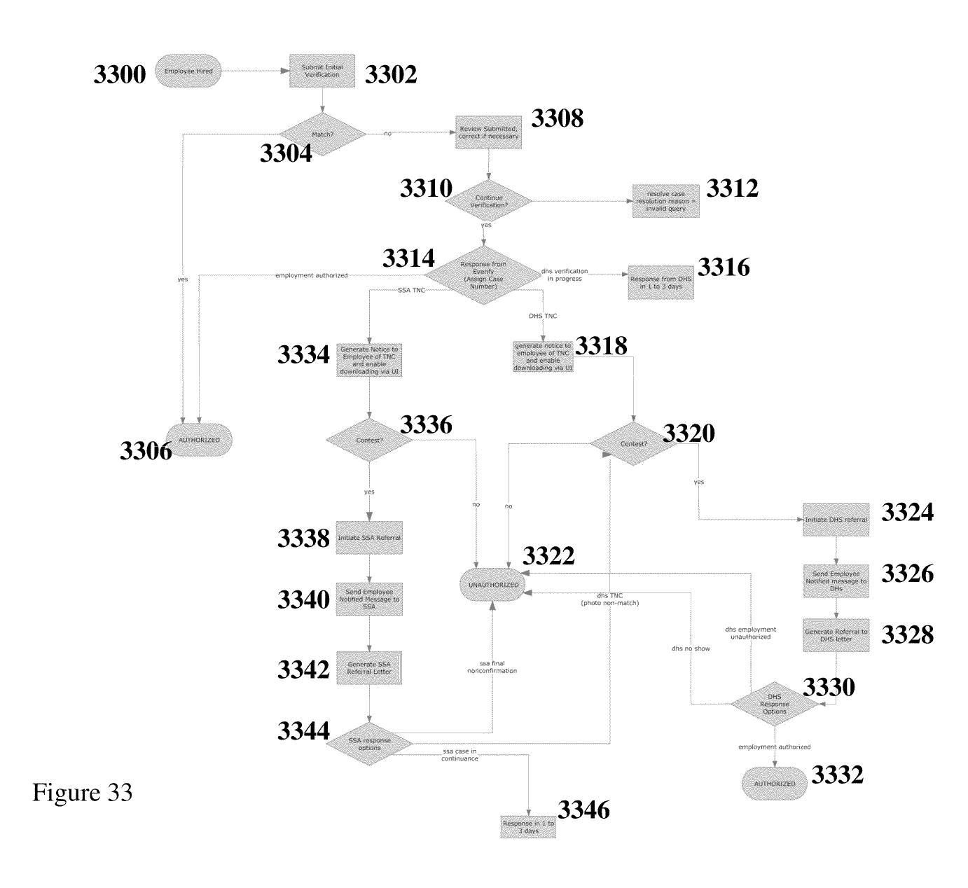

FIG. 33 illustrates how an employee is authorized to work. Once an employee is first hired 3300, an initial verification is then submitted 3302. The system then checks to see if there is a match 3304. If there is a match, then the employee is authorized 3306. If there is no match, the submission if reviewed and corrected if necessary 3308. Then the system determines if the verification continues 3310. If the system does not continue with the verification, the process then ends up resolving the case as an invalid inquiry 3312. The process then proceeds to the E-verify module 3314. If employment if authorized, the process proceeds the authorized module 3306. However, if there is a TNC from the department of homeland security (DHS), the process indicates that a response is due from the DHS in 1 to 3 days 3316. The system also generates a notice to the employee of the TNC 3318 allows the notice to be viewed through the system. A decision to contest 3320 is then made. If the TNC is not contested, the process ends up at the unauthorized module 3322. If the TNC is contested, the process then initiates a DHS referral 3324, a notice 3326 is sent to the employee along with referral to DHS letter 3328. Then, DHS has to respond 3330. If DHS authorizes the employee, the process ends up at the authorized module 3332. However, if DHS does not show, or there is photo non-match, or if DHS does not authorize employment for another reason, the process ends up at the unauthorized module 3322.

If the Social Security Administration (SSA) has an issue with the verification, a notice is generated to the employee of the TNC 3334 and enable downloading through the system. Then a decision has to be made on whether 3336 to contest the TNC. If the TNC is not contested, the process ends up at the unauthorized module 3322. If the TNC is contested, a referral is initiated to the SSA 3338. The process then sends the employee notification 3340, and generates a SSA referral 3342. The SSA then has a few options 3344. If the SSA issues a final non-confirmation, the process ends up at the unauthorized module 3322. However, the SSA can also send the issue to DHS to contest 3320. In addition, the SSA can continue the case and the process will record that a response is due in 1 to 3 days 3346.

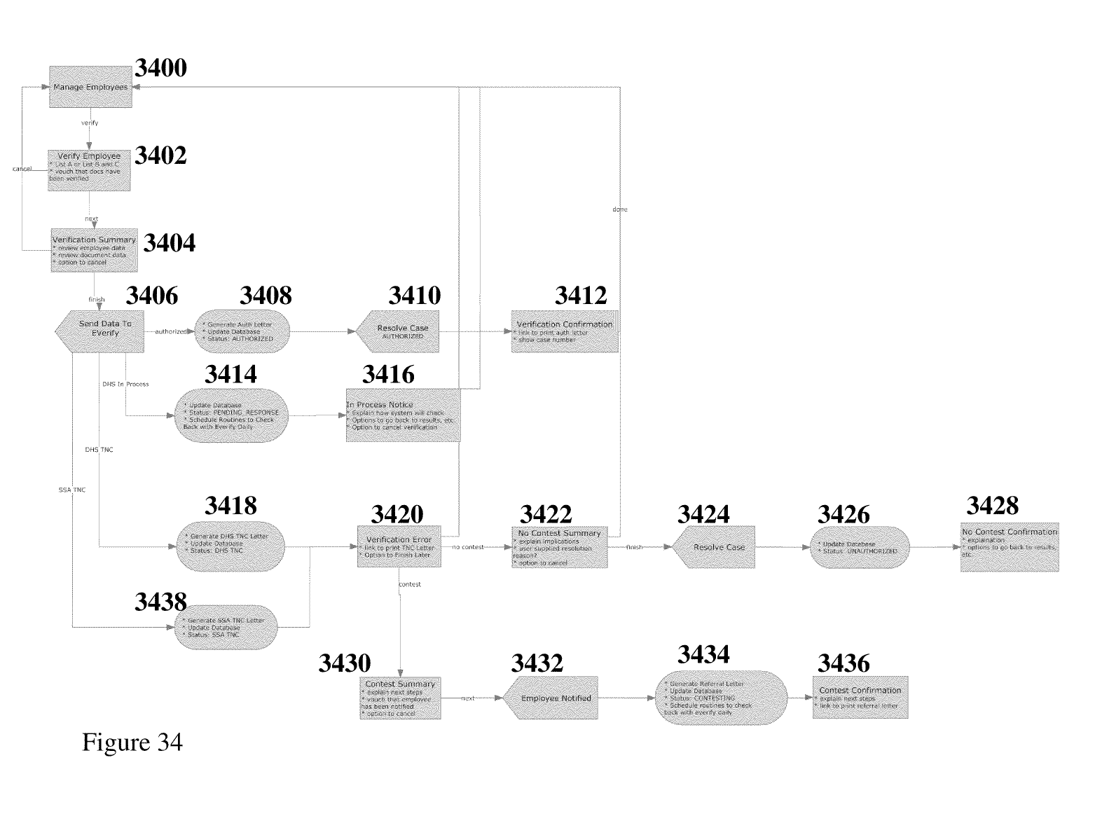

FIG. 34 illustrates how the system manages employee verification. The manage employees module 3400 allows a User to proceed to a verify employees module 3402. However, the User can cancel out of the module 3402 and to back to the manage employees module 3400. If the User proceeds to the verification module 3404, the User can review employee data, review document data and option to cancel out. Then, the process sends the data to E-verify as represented by module 3406. If the employee is authorized, an authorization letter is generated, the database is updated and status is updated in module 3408. The process then indicates that the case is resolved as authorized 3410 and then proceeds to the verification confirmation module 3412. A link is then shown to print authorization letter and shows the case number.

If the employee does not get authorized and the response from DHS is pending, the database is updated, the status becomes pending response, and the system indicates that E-verify should be checked daily as represented by module 3414. Then, an in process notice is displayed that explains how the system will check back, options to go back to results and option to cancel verification as represented by module 3416.

However, if the system comes back with a DHS TNC, the process goes to generate a DHS TNC letter, updates the database, and updates the status to DHS TNC as represented in module 3418. The process then goes to the verification error module 3420. The User then has the option to print TNC letter, the option to finish later and the option to contest the TNC or not to contest the TNC. If the TNC is not contested, the process goes to the no contest summary module 3422 that explains the implications and the User has an option to explain a resolution reason and the option to cancel. The process then goes to the resolve case module 3424 and subsequently proceeds to the module 3426 that updates the database and status is indicated as unauthorized. The process then goes to a No Contest Confirmation module 3428 that includes an explanation and options to go back to results.

If the User decides to contest the TNC, the process then goes to the contest summary module 3430 where the next steps are explained and includes an option to cancel. The process then notifies the employee 3432 and proceeds to generate the referral letter, updates the database, changes the status to contesting and schedules to check back with E-verify daily as represented by module 3434. The process then proceeds to a Contest Confirmation module 3436 which explains next steps and includes a link to print the referral letter.

If a SSA TNC results from E-verify, the process generates a SSA TNC letter, updates the database, and the status is updated to SSA TNC as represented in module 3438.

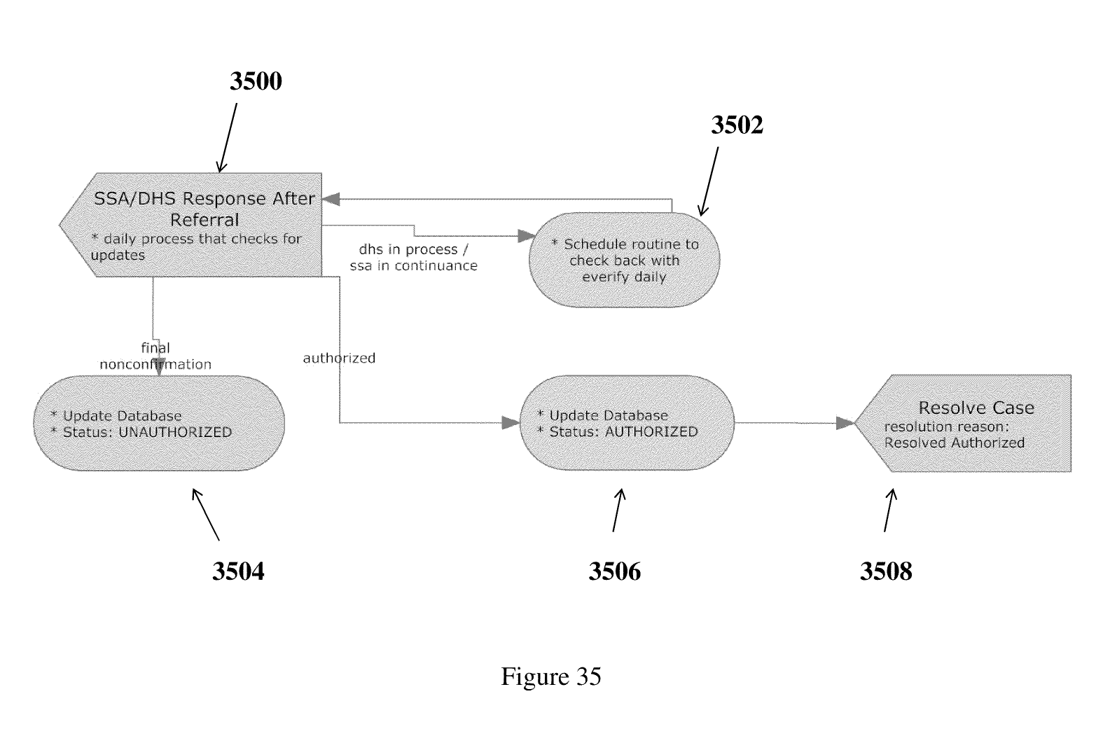

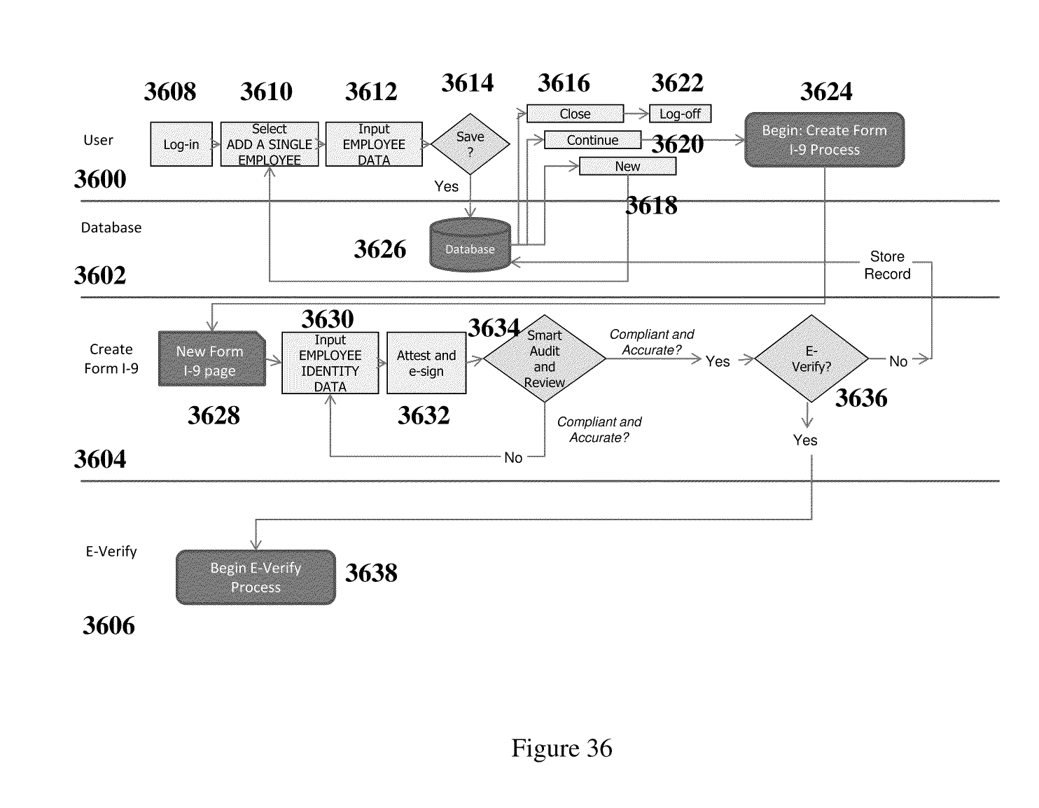

FIG. 35 shows how the system resolves SSA TNCs and DHS TNCs. The rechecking process 3500 schedules a routine 3502 to check back with E-verify daily. Once E-verify determines a result, either a final non-confirmation is issued or the verification is authorized. If a final non-confirmation results, the database is updated, and the status is unauthorized as represented by module 3504. If an authorization results, the database is updated and status is authorized as represented by module 3506. The process then goes to the resolve case module 3508. The resolution release is then indicted to resolved authorized.

FIG. 36 illustrates how the system works from a User 3600 level, a database 3602 level, a creation of new Form I-9 3604 level, and an E-verify 3606 level. As shown, a User 3600 logs-in 3608, then can select to add a single employee 3610 and then inputs the employee data 3612. If the User 3600 chooses to save 3614, the employee information will be saved in the database 3626. The User 3600 will then have the option of adding another new employee 3618, close the session 3616 and then logging off 3622. However, the User 3600 also has the option of continuing 3620 to create a Form I-9 3624. A new Form I-9 page 3628 is then created. The user then inputs the employee identity data 3630, attests the data and e-signs it 3632 and then proceeds to smart audit and review 3634. If the information is not accurate and compliant, the process goes back to the input screen 3630. If the information is accurate and complaint, the process goes to the E-verify module 3636. If the User 3600 chooses to not to E-verify at this time, record is stored in the database 3626. However, if the User 3600 chooses to E-verify at this time, the E-verify process is started 3638.

Thus, specific embodiments and applications of electronic verification software have been disclosed. Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A method of managing employment verification for current and potential employees, comprising:
entering personal information of a person into a database;
completing an online, accurate and compliant Form I-9
storage of an on-line Form I-9
verifying the Form I-9 with the department of homeland security (DHS) and the social security administration (SSA) whether the person can become an employee;
if a temporary non-confirmation (TNC) is issued from the SSA, automatically pre-completing and printing a TNC notice from the DHS to the employee; and automatically printing a referral letter to the SSA for the employee.

2. The method of claim 1 wherein the automatically pre-completes and prints the referral letter in English and Spanish.

3. The method of claim 1 further comprising contesting TNC and notifying the person of the contested TNC.

4. The method of claim 1 wherein the verifying is electronic and is rechecked periodically.

5. The method of claim 1 further comprising managing employee current Form I-9 status.

6. The method of claim 1 further comprising managing compliance of employment verification of at least one vendor.

7. The method of claim 1, further comprising inviting remote employees to fill out Form I-9 information.
